(19) United States
(12) Patent Application Publication
(10) Pub. No.: US 2017/0370587 A1
(43) Pub. Date: Dec. 28, 2017

(54) SYSTEMS AND METHODS FOR CONTROLLING FLAME INSTABILITY

(71) Applicant: KING ABDULLAH UNIVERSITY OF SCIENCE AND TECHNOLOGY, Thuwal (SA)

(72) Inventors: Min Suk CHA, Thuwal (SA); Yuan XIONG, Thuwal (SA); Suk Ho CHUNG, Thuwal (SA)

(21) Appl. No.: 15/535,629

(22) PCT Filed: Jan. 13, 2016
(86) PCT No.: PCT/IB2016/050145

§ 371 Date: Jun. 13, 2017

Related U.S. Application Data
(60) Provisional application No. 62/103,627, filed on Jan. 15, 2015.

(51) Int. Cl. F23R 3/20; F23N 5/24; F02C 7/224; F23C 99/00; F23D 14/20; F23N 5/12

(52) U.S. Cl. CPC F23R 3/20; F23C 99/001; F23D 14/20; F23N 5/242; F02C 7/224; F23N 5/245; F23N 2025/04; F23N 5/123

(57) ABSTRACT

A system for controlling flame instability. The system may include a nozzle coupled to a fuel supply line, an insulation housing coupled to the nozzle, a combustor coupled to the nozzle via the insulation housing, where the combustor is grounded, a pressure sensor coupled to the combustor and configured to detect pressure in the combustor, and an instability controlling assembly coupled to the pressure sensor and to an alternating current power supply. The instability controlling assembly can control flame instability of a flame in the system based on pressure detected by the pressure sensor by applying a voltage from the alternating current power supply to the system to create an electric field.

### CROSS REFERENCE TO RELATED APPLICATIONS

This application claims priority to U.S. Provisional Patent Application Ser. No. 62/103,627, filed Jan. 15, 2015, which is hereby incorporated by reference in its entirety.

### BACKGROUND

### 1. Field of the Invention

The present invention relates generally to systems and methods for controlling flame instability, such as that which may occur, for example, in a combustor (e.g., in a turbine).

### 2. Description of Related Art

Examples of flames exposed to an electric field are disclosed, for example, in Korean Patent No. 10-0713708 and in Laminar Jet Diffusion Flame under AC Electric Fields, 9th Asia-Pacific Conference on Combustion, Gyeongju Hilton, Gyeongju, Korea, May 19-22, 2013.

### SUMMARY

This disclosure includes embodiments of systems and methods for controlling flame instability, such as that which may occur, for example, in a combustor (e.g., in a turbine). Thermo-acoustic and flame instability in a variety of applications, such as in commercial combustors (e.g., in a turbine, such as a gas turbine), can reduce efficiency. The present systems and methods can control thermo-acoustic and flame instability in such applications, such as by preventing, mitigating, and/or eliminating thermo-acoustic and flame instability caused by, for example, pressure fluctuations. The present systems and methods can be configured to achieve such an effect rapidly, such as in 1 second, 0.5 seconds, 100 milliseconds, 50 milliseconds, 25 milliseconds, 10 milliseconds, 5 milliseconds, or less, and with little power consumption (e.g., 0.5 Watts, 0.1 Watts, 0.05 Watts, or less).

Some embodiments of the present systems (e.g., for controlling flame instability) comprise a nozzle couplable to a fuel supply line; a combustor couplable to the nozzle; a pressure sensor coupled to the combustor and configured to detect pressure in the combustor; and an instability controlling assembly couplable to the pressure sensor and to an alternating current power supply; where, the instability controlling assembly can control flame instability of a flame in the system based on pressure detected by the pressure sensor, if the system is coupled to the alternating current power supply, the nozzle is coupled to a fuel supply line and to the combustor, the instability controlling assembly is coupled to the pressure sensor and the alternating current power supply, and the system is activated to form a flame.

Some embodiments of the present systems (e.g., for controlling flame instability) comprise a nozzle coupled to a fuel supply line; an insulation housing coupled to the nozzle; an alternating current power supply coupled to the nozzle; a combustor coupled to the insulation housing such that the fuel supply line and the combustor are in fluid communication through the nozzle, where the combustor is grounded; a pressure sensor coupled to the combustor and configured to detect pressure in the combustor; and an instability controlling assembly coupled to the pressure sensor and to the alternating current power supply, the instability controlling assembly comprising: an analog to digital converter; a Fast Fourier Transform module; a function generator; and a voltage amplifier; where, the instability controlling assembly can control flame instability of a flame in the system based on pressure detected by the pressure sensor, if the system is activated to form a flame.

Some embodiments of the present methods (e.g., for controlling flame instability in a combustor) comprise activating a system comprising a combustor and a nozzle coupled to and insulated from the combustor to generate an electric field and to form a flame; establishing a maximum endurable pressure in the combustor; detecting a pressure in the combustor; if a pressure is detected, determining a primary frequency and a mean peak pressure of the pressure; if the mean peak pressure exceeds the maximum endurable pressure: generating an alternating current signal having a frequency equal to the primary frequency of the detected pressure and having a phase difference of 180 degrees from the detected pressure; and amplifying the alternating current signal that is generated; and if the mean peak pressure continues to exceed the maximum endurable pressure, increasing the phase difference of the alternating current signal that is generated.

The term “coupled” is defined as connected, although not necessarily directly, and not necessarily mechanically. Two items are “couplable” if they can be coupled to each other. Unless the context explicitly requires otherwise, items that are couplable are also decouplable, and vice-versa. One non-limiting way in which a first structure is couplable to a second structure is for the first structure to be configured to be coupled (or configured to be couplable) to the second structure. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The term “detect” (and any form of detect, such as “detects,” “detected,” and “detecting”) is used broadly throughout this disclosure to include the receiving or gathering of information from an area and any resulting calculations with and/or manipulations of such information and should include terms (and derivatives of such terms) such as determine, measuring, identifying, receiving, calculating, and similar terms.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a system, or a component of a system that “comprises,” “has,” “includes” or “contains” one or more elements or features possesses those one or more elements or features, but is not limited to possessing only those elements or features. Likewise, a method that “comprises,” “has,” “includes” or “contains” one or more steps possesses those one or more steps, but is not limited to possessing only those one or more steps. Additionally, terms such as “first” and “second” are used only to differentiate structures or features, and not to limit the different structures or features to a particular order.

Any embodiment of any of the present systems and methods can consist of or consist essentially of—rather than comprise/include/contain/have—any of the described elements and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. At least some of the figures depict graphical symbols or representations that will be described in the specification and/or understood by those of ordinary skill in the art.

FIG. 1 depicts one embodiment of a cross-section of a system coupled to an alternating current power source such that an electric field is generated.

FIG. 2 depicts a flame at various time intervals that is formed by system that is coupled to an alternating current power source such that an electric field is generated.

FIG. 3 depicts annotated flames in Mie scattering images taken with a particle image velocimetry (PIV) laser that are formed by a system that is coupled to an alternating current power source such that an electric field is generated.

FIG. 4 depicts a graphical representation of an alternating current frequency applied to a system versus the pulsing frequency of a flame formed by the system.

FIG. 5 depicts another embodiment of a cross-section of a system coupled to an alternating current power source such that an electric field is generated.

### DESCRIPTION OF ILLUSTRATIVE EMBODIMENTS

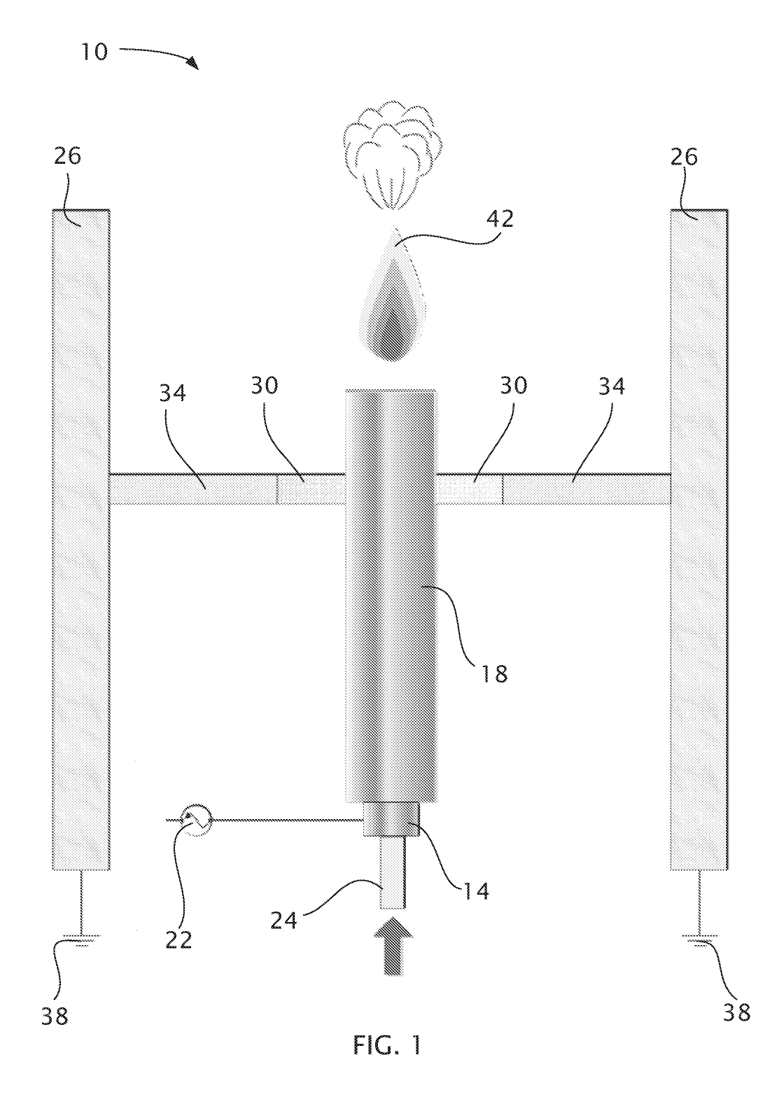

Referring now to FIG. 1, shown therein as numeral 10 is one embodiment of the present systems. In the embodiment shown, system 10 comprises jet nozzle 14, which is couplable (and is coupled, in the embodiment shown) to jet body 18. In some embodiments, jet nozzle 14 and jet body 18 are unitary (e.g., formed of a single piece of material). Jet nozzle 14 and jet body 18 may be any suitable conductive material, such as a metal, including metal alloys (e.g., steel, stainless steel, silver, gold, copper, and the like). In the embodiment shown, jet nozzle 14 is coupled to an alternating current (AC) power supply 22 such that a voltage can be applied to jet nozzle 14 (e.g., by passing an AC current to jet nozzle 14). In other embodiments, jet body 18 is coupled to AC power supply 22. In some embodiments, a voltage applied to jet nozzle 14 by AC power supply 22 is 1 to 5 kilovolt, 5 to 10 kilovolts, 10 to 15 kilovolts, 15 to 20 kilovolts, 20 to 25 kilovolts, 25 to 30 kilovolts, 30 to 35 kilovolts, 35 to 40 kilovolts, 40 to 45 kilovolts or more; and in other embodiments, a voltage applied to jet nozzle 14 by AC power supply 22 can be less than 1 kilovolt. In some embodiments, a frequency of the current applied to jet nozzle 14 by AC power supply 22 is 1 to 10 Hertz, 10 to 20 Hertz, 20 to 30 Hertz, 30 to 40 Hertz, 40 to 50 Hertz, 50 to 100 Hertz, 100 to 200 Hertz, 200 to 300 Hertz, 300 to 400 Hertz, 400 to 500 Hertz, 500 to 600 Hertz, 600 to 700 Hertz, 700 to 800 Hertz, 800 to 900 Hertz, 900 Hertz to 1 Kilohertz, 1 to 2 Kilohertz, 2 to 3 Kilohertz, 3 to 4 Kilohertz, 4 to 5 Kilohertz, 5 to 6 Kilohertz, 6 to 7 Kilohertz, 7 to 8 Kilohertz, 8 to 9 Kilohertz, 9 to 10 Kilohertz or more; and in other embodiments, a frequency of the current applied to jet nozzle 14 by AC power supply 22 can be less than 1 Hertz. Further, AC power supply 22 can be configurable to produce any suitable wave, such as sinusoidal waves, triangular waves, square waves, sawtooth waves, and the like. In the embodiment shown, jet nozzle 14 is further coupled to fuel inlet 24, which is configured to permit introduction of fuel (e.g., gaseous fuel to form a nonpremixed flame) into jet nozzle 14 and jet body 18. System 10 further comprises cover 26, which is coupled to jet body 18 by first inner material 30 and second inner material 34 such that cover 26 does not physically contact jet nozzle 14 or jet body 18. First inner material 30 comprises any suitable insulator/dielectric, such as ceramic (e.g., sintered-alumina ceramic), glass, acrylic, mica, nylon, rubber, plastic/thermoplastics, sapphire, quartz, low-thermal-expansion borosilicate glass (e.g., Pyrex), silicon carbide, and the like. Second inner material 34 can be any suitable insulator/dielectric, such as ceramic (e.g., sintered-alumina ceramic), glass, acrylic, mica, nylon, rubber, plastic/thermoplastics, sapphire, quartz, low-thermal-expansion borosilicate glass (e.g., Pyrex), silicon carbide, and the like or a conductor, such as a metal, including metal alloys (e.g., steel, stainless steel, silver, gold, copper, and the like). Cover 26 comprises any suitable conductive material, such as a metal, including metal alloys (e.g., steel, stainless steel, silver, gold, copper, and the like), and is grounded (e.g., electrically) to ground 38. In the embodiment shown, cover 26 is cylindrical; however, in other embodiments, cover 26 can be any suitable shape, such as rectangular, ovular, polygonal, and the like. In the embodiment shown, the distance between cover 26 and jet nozzle 14 and/or jet body 18 is 1 centimeter, 2, centimeters, 3 centimeters, 4 centimeters, 5 centimeters, 6 centimeters, 7 centimeters, 8 centimeters, 9 centimeters, 10 centimeters, 11 centimeters, 12 centimeters, or more; and in other embodiments, distance between cover 26 and jet nozzle 14 and/or jet body 18 is less than 1 centimeter. A shorter distance between cover 26 and jet nozzle 14 and/or jet body 18 generally corresponds to a stronger electric field if AC power supply 22 is activated to apply voltage to jet nozzle 14.

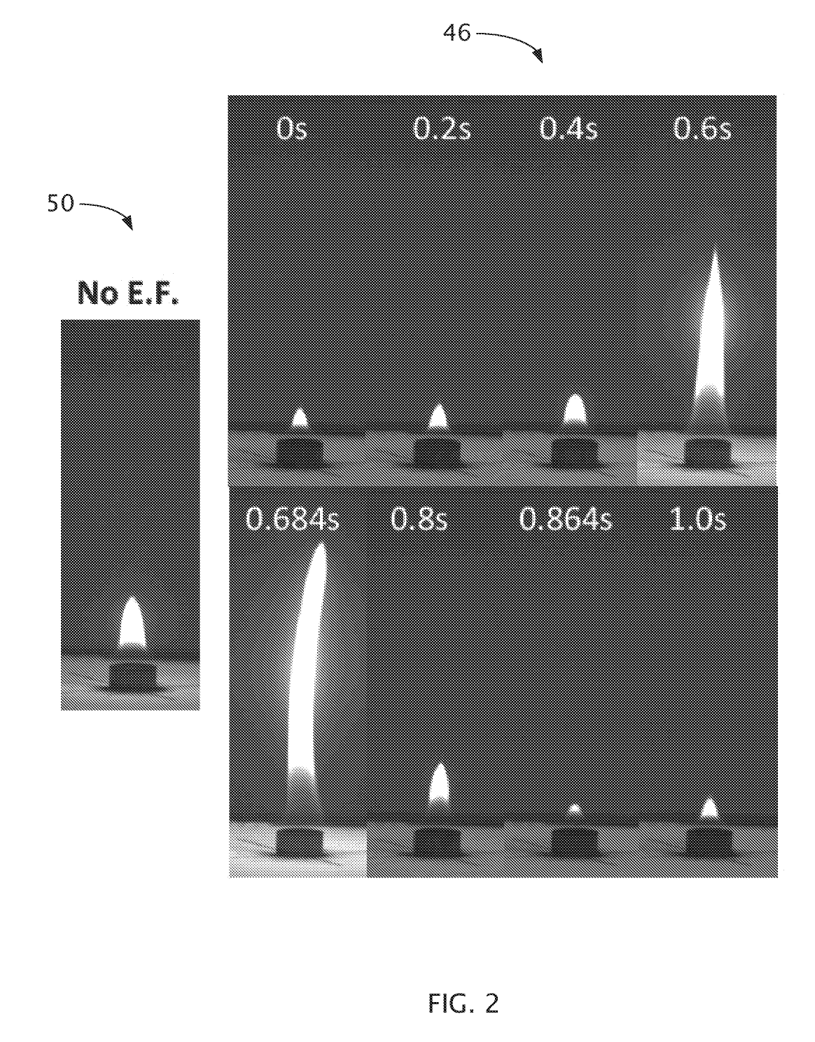

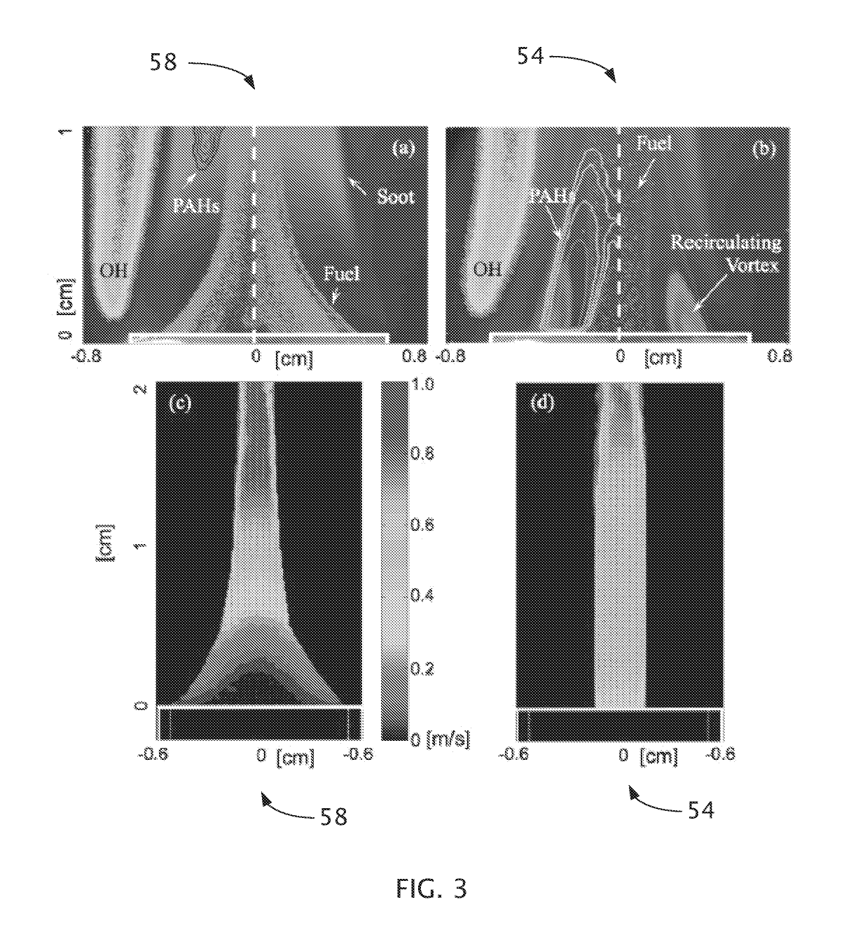

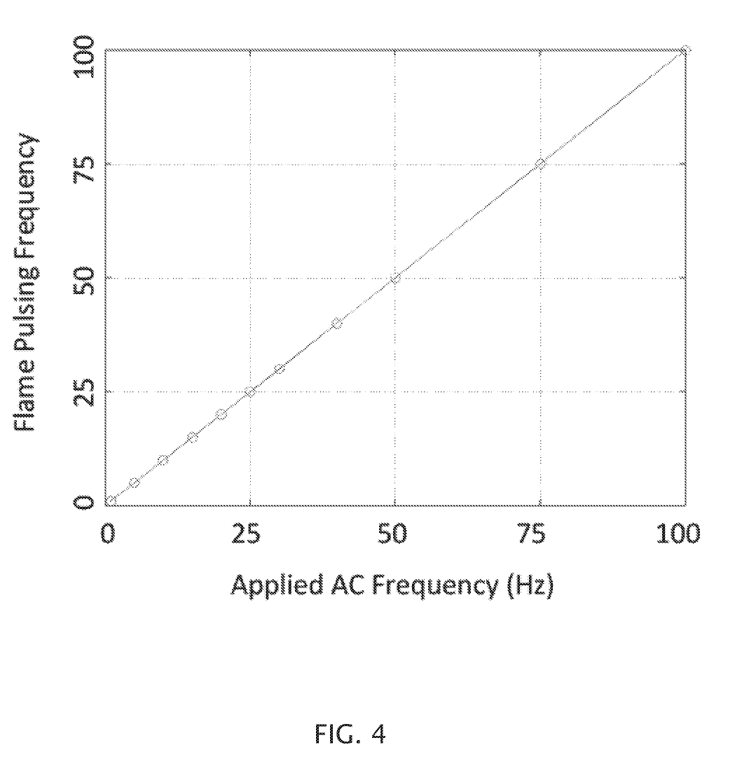

In the embodiment shown in FIG. 1, if fuel is introduced into jet nozzle 14 and jet body 18 through fuel inlet 24 and system 10 is activated to form flame 42, AC power supply 22 can also be activated to apply voltage to jet nozzle 14 to cause flame 42 to pulse (e.g., to increase and decrease in size with respect to a given frequency). For example, FIG. 2 depicts burner and flame configuration 46 at various intervals over one second, where a voltage of 15 kilovolts at a frequency of 1 Hertz was applied to burner and flame configuration 46 by an AC power source, as compared to burner and flame configuration 50 that is not influenced by an electric field. As depicted in FIGS. 2 and 4, a flame pulses with the same frequency as, a substantially similar frequency as, or a proportional frequency to the frequency applied to the burner by the AC power source. Flame pulsing under such conditions and similar conditions is due at least in part to an electrohydrodynamic valve resulting from an electromagnetically induced vortex, which is depicted in FIG. 3. Such a vortex is caused by the interaction of a flame and an electric field. As depicted in FIG. 3, burner and flame configuration 54 depicts an electromagnetically induced vortex encouraging fuel from a burner into a given configuration depending on the frequency of an applied current, which results in a pulsing phenomena, as compared to burner and flame configuration 58 that is not influenced by an electric field.

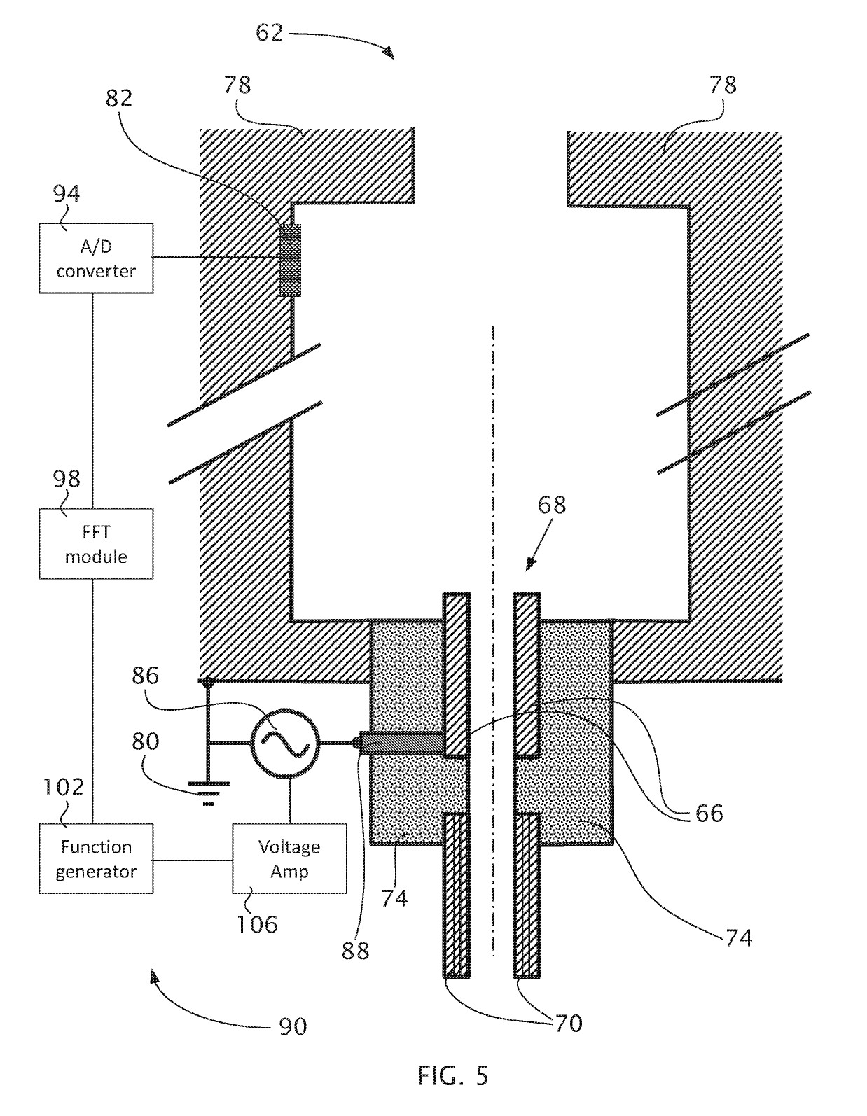

Referring now to FIG. 5, shown therein as numeral 62 is another embodiment of the present systems. System 62 comprises nozzle 66, which is couplable to fuel supply line 70 (and is coupled to fuel supply line 70, in the embodiment shown). Nozzle 66 can be any suitable conductive material, such as a metal, including metal alloys (e.g., steel, stainless steel, silver, gold, copper, and the like). Further, nozzle 66 can comprise any suitable shape, such as cylindrical, ovular, rectangular, polygonal, and the like. Nozzle outlet 68 of nozzle 66 can comprise one or more sharp edges, which can assist in increasing electric field intensity of an electric field resulting from system 62, which is discussed further below. Nozzle 66 can comprise a diameter of approximately 1 millimeter to 100 millimeters; however, in other embodiments, nozzle 66 may comprise a diameter of less than 1 millimeter or greater than 100 millimeters. System 62 further comprises insulation housing 74, which is couplable to nozzle 66 (e.g., and is coupled to nozzle 66, in the embodiment shown). Insulation housing 74 can comprise any suitable insulator/dielectric, such as ceramic (e.g., sintered-alumina ceramic), glass, acrylic, mica, nylon, rubber, plastic/thermoplastics sapphire, quartz, low-thermal-expansion borosilicate glass (e.g., Pyrex), silicon carbide, and the like. System 62 further comprises combustor 78, which is couplable to nozzle 66 (e.g., and is coupled to nozzle 66 via insulation housing 74, in the embodiment shown, such that nozzle 66 is prevented from being in electrical communication with combustor 78 and/or fuel supply line 70) such that fuel supply line 70 and combustor 78 are in fluid communication via nozzle 66. Combustor 78 can be any suitable conductive material, such as a metal, including metal alloys (e.g., steel, stainless steel, silver, gold, copper, and the like). Insulation housing 74 can provide any suitable separation distance between nozzle 66 and combustor 78 and/or fuel supply line 70, such as a distance greater than a breakdown distance between any two conducting elements (e.g., 80 millimeters, 85 millimeters, 90 millimeters, 95 millimeters, 100 millimeters, 105 millimeters, 110 millimeters, 115 millimeters, 120 millimeters, or more). Furthermore, insulation housing 74 can comprise a curved (e.g., arcuate, wavy, and the like) inner surface to provide an extended spark path (e.g., to improve flashover protection). In the embodiment shown, combustor 78 is grounded (e.g., electrically) to ground 80. Combustor 78 can comprise substantially the same shape as nozzle 66, such as cylindrical, ovular, rectangular, polygonal, and the like; however, in other embodiments, combustor may not comprise the substantially the same shape as nozzle 66. System 62 further comprises pressure sensor 82 coupled to combustor 78 and configured to detect pressure in combustor 78 (e.g., such that system 62 can determine whether there are pressure fluctuations in combustor 78, such as by comparison of the detected pressure to an average pressure in combustor 78, by comparison of the detected pressure to a preprogrammed pressure, by comparison of the detected pressure to a manually adjustable user input pressure, by calibrating pressure sensor 82 to zero pressure in combustor 78 such that any detected pressure represents a pressure fluctuation, and the like). System 62 further comprises AC power supply 86 couplable to nozzle 66 (e.g., and is coupled to nozzle 66 via plug 88, in the embodiment shown) such that AC power supply 86 can pass an alternating current to nozzle 66 in order to apply a voltage to nozzle 66. In some embodiments, a voltage applied to nozzle 66 by AC power supply 86 is 1 to 5 kilovolt, 5 to 10 kilovolts, 10 to 15 kilovolts, 15 to 20 kilovolts, 20 to 25 kilovolts, 25 to 30 kilovolts, 30 to 35 kilovolts, 35 to 40 kilovolts, 40 to 45 kilovolts or more; and in other embodiments, a voltage applied to nozzle 66 by AC power supply 86 can be less than 1 kilovolt. In some embodiments, a frequency of the current applied to nozzle 66 by AC power supply 86 is 1 to 10 Hertz, 10 to 20 Hertz, 20 to 30 Hertz, 30 to 40 Hertz, 40 to 50 Hertz, 50 to 100 Hertz, 100 to 200 Hertz, 200 to 300 Hertz, 300 to 400 Hertz, 400 to 500 Hertz, 500 to 600 Hertz, 600 to 700 Hertz, 700 to 800 Hertz, 800 to 900 Hertz, 900 Hertz to 1 Kilohertz, 1 to 2 Kilohertz, 2 to 3 Kilohertz, 3 to 4 Kilohertz, 4 to 5 Kilohertz, 5 to 6 Kilohertz, 6 to 7 Kilohertz, 7 to 8 Kilohertz, 8 to 9 Kilohertz, 9 to 10 Kilohertz or more; and in other embodiments, a frequency of the current applied to nozzle 66 by AC power supply 86 can be less than 1 Hertz. Further, AC power supply 86 can be configurable to produce any suitable wave, such as sinusoidal waves, triangular waves, square waves, sawtooth waves, and the like. If activated, system 62 is configured to form a flame in combustor 78 and to produce an electric field.

System 62 further comprises instability controlling assembly 90 couplable to pressure sensor 82 and AC power supply 86 (e.g., and is coupled to pressure sensor 82 and AC power supply 86, in the embodiment shown). Instability controlling assembly 90 can control flame instability of a flame in system 62 (e.g., and, more specifically, a flame in combustor 78) based on pressure in combustor 78 detected by pressure sensor 82. For example, in the embodiment shown, instability controlling assembly 90 comprises analog to digital (A/D) converter 94, Fast Fourier Transform (FFT) module 98, function generator 102, and voltage amplifier 106. A/D converter 94 can, for example, convert information (e.g., information relating to a pressure or pressure fluctuation) detected by pressure sensor 82 into digital information representing, for example, amplitude of a detected pressure or pressure fluctuation. Digital information from A/D converter 94 can pass to FFT module 98, and FFT module 98 can implement an algorithm to, for example, determine a primary frequency of any pressure or pressure fluctuation detected by pressure sensor 82, as well as a mean peak pressure of any pressure or pressure fluctuation detected by pressure sensor 82. System 62 can be configured to determine if the mean peak pressure exceeds a maximum endurable pressure (e.g., which can be input and/or adjusted by a user). If a maximum endurable pressure is exceeded, function generator 102 can generate an AC signal with the same frequency as or a substantially similar frequency to the primary frequency of the pressure or pressure fluctuation detected by pressure sensor 82 and having a 180 degree phase difference between the pressure or pressure fluctuation detected by pressure sensor 82. Frequency and phase of the AC signal generated by function generator 102 can be manually adjustable by a user and/or automatically adjusted by system 62. Function generator 102 can produce any suitable wave, such as sinusoidal waves, triangular waves, square waves, sawtooth waves, and the like. Voltage amplifier can magnify any input signal from function generator 102 by any suitable amount, such as by 1 to 5 kilovolt, 5 to 10 kilovolts, 10 to 20 kilovolts, 20 to 30 kilovolts, 30 to 40 kilovolts, 40 to 50 kilovolts, 50 to 60 kilovolts, or more. To the extent pressure or pressure fluctuations continue to be detected by pressure sensor 82, function generator 102 or another component of system 62 can be adjusted (e.g., manually by a user or automatically by system 62) to increase a phase delay from 180 degrees (e.g., such as to 185 degrees, 190 degrees, 195 degrees, 200 degrees, or more) until a mean peak pressure is a desired percentage below a maximum endurable pressure (e.g., 20 to 15 percent below, 15 to 10 percent below, 10 to 5 percent below, 5 to 1 percent below, or less).

In some embodiments, brightness of a flame can fluctuate with the same or a similar frequency as or a proportional frequency to pressure in system 62. In such an embodiment, system 62 can include one or more photodiodes or photo sensors (e.g., in place of or in addition to pressure sensor 82) that are configured to detect light from the flame such that flame brightness can be detected/determined. One or more photodiodes or photo sensors can be positioned within system 62 (e.g., near nozzle outlet 68) such that light from the flame engages the one or more photodiodes or photo sensors. One or more photodiodes or photo sensors can be used in the same or a similar way as pressures sensor 82 to control flame instability (e.g., in a combustor).

The present disclosure also includes methods for controlling flame instability (e.g., in a combustor (e.g., combustor 78)), such as activating a system (e.g., system 62) comprising a combustor

(e.g., combustor 78) and a nozzle (e.g., nozzle 66) coupled to and insulated from the combustor to generate an electric field and to form a flame; establishing a maximum endurable pressure in the combustor; detecting a pressure in the combustor; if a pressure is detected, determining a primary frequency and a mean peak pressure of the detected pressure; if the mean peak pressure exceeds the maximum endurable pressure: generating an alternating current signal having a frequency equal to the primary frequency of the detected pressure and having a phase difference of 180 degrees from the detected pressure; and amplifying the alternating current signal that is generated; and if the mean peak pressure continues to exceed the maximum endurable pressure, increasing the phase difference of the alternating current signal that is generated (e.g., such as to 180 to 185 degrees, 185 to 190 degrees, 190 to 195 degrees, 195 to 200 degrees, or more).

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present systems and methods are not intended to be limited to the particular forms disclosed. Rather, they include all modifications and alternatives falling within the scope of the claims, and embodiments other than the ones shown may include some or all of the features of the depicted embodiments. For example, components may be combined as a unitary structure and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A system for controlling flame instability, comprising:
a nozzle couplable to a fuel supply line;
a combustor couplable to the nozzle;
a pressure sensor couplable to the combustor and configured to detect a pressure in the combustor; and
an instability controlling assembly couplable to the pressure sensor and to an alternating current power supply;
where, the instability controlling assembly is configured to control a flame instability of a flame in the system based on the pressure detected by the pressure sensor by applying a voltage from the alternating current power supply to the system.

2-3. (canceled)

4. The system of claim 1, wherein the voltage applied to the system is from 1 kilovolt to 45 kilovolts.

5. The system of claim 1, wherein a frequency of a current applied to the system is from 1 Hertz to 10 Kilohertz.

6. The system of claim 1, wherein the alternating current power supply is configured to produce one or more of sinusoidal waves, triangular waves, square waves, and sawtooth waves.

7. The system of claim 1, wherein the voltage is applied to the nozzle.

8. The system of claim 7, further comprising:
a fuel inlet;
a jet body;
a cover; and
one or more of a first material and a second material,
wherein the nozzle is couplable to the fuel inlet, the fuel inlet being configured to introduce fuel into the nozzle and the jet body, and
wherein the cover is couplable to the jet body by the one or more of the first material and the second material such that the cover does not physically contact the nozzle or the jet body.

9. The system of claim 8, wherein the nozzle, the jet body, and the cover are formed of a conductive material, and wherein at least one of the first material and the second material comprises an insulator/dielectric.

10. The system of claim 8, wherein a distance between the cover and the nozzle is from 1 centimeter and 12 centimeters.

11. A system for controlling flame instability, comprising:
a nozzle coupled to a fuel supply line;
an insulation housing coupled to the nozzle;
an alternating current power supply coupled to the nozzle;
a combustor coupled to the insulation housing such that the fuel supply line and the combustor are in fluid communication through the nozzle, where the combustor is grounded;
a pressure sensor coupled to the combustor and configured to detect a pressure in the combustor; and
an instability controlling assembly coupled to the pressure sensor and to the alternating current power supply, the instability controlling assembly controlling a flame instability of a flame in the system based on the pressure detected by the pressure sensor by applying a voltage from the alternating current power supply to the system to create an electric field.

12. The system of claim 11, wherein the instability controlling assembly comprises:
an analog to digital converter;
a Fast Fourier Transform (FFT) module;
a function generator; and
a voltage amplifier.

13. The system of claim 12,
wherein the analog to digital converter is configured to convert pressure information sensed by the pressure sensor into digital information,
wherein the FFT module determines a primary frequency and a mean peak pressure from the digital information,
wherein the function generator generates an alternating current signal when the mean peak pressure exceeds a maximum endurable pressure, the alternating current signal having the same or substantially the same frequency as the primary frequency and having a 180 degree phase difference from the detected pressure, where the 180 degree phase difference of the alternating current signal is increased if the mean peak pressure continues to exceed the maximum endurable pressure, and
wherein the voltage amplifier magnifies an input signal from the function generator resulting in the voltage applied to create the electric field.

14. The system of claim 11, wherein the voltage applied to the system is from 1 kilovolt to 45 kilovolts.

15. The system of claim 11, wherein a frequency of current applied to the system is from 1 Hertz to 10 Kilohertz.

16. The system of claim 11, wherein the voltage is applied to the nozzle.

17. The system of claim 16, further comprising a nozzle outlet of the nozzle, wherein the nozzle outlet comprises one or more sharp edges configured to increase an electric field intensity of the electric field.

18. The system of claim 16, wherein the nozzle comprises a diameter of 1 millimeter to 100 millimeters.

19. The system of claim 16, wherein the insulation housing comprises an insulator/dielectric, and wherein the combustor is coupled to the nozzle via the insulation housing such that nozzle is prevented from being in electrical communication with combustor and/or fuel supply line.

20. The system of claim 19, wherein the insulation housing provides a distance from the nozzle to the combustor and/or fuel supply line of from 80 millimeters to 120 millimeters.

21. The system of claim 19, wherein the insulation housing comprises a curved inner surface providing an extended spark path.

22. A method for controlling flame instability in a combustor, comprising:
activating a system comprising a combustor and a nozzle coupled to and insulated from the combustor to generate an electric field and to form a flame;
detecting a pressure in the combustor;
determining a primary frequency and a mean peak pressure of the detected pressure;
if the mean peak pressure exceeds a maximum endurable pressure:
generating an alternating current signal having a frequency equal to the primary frequency of the detected pressure and having a phase difference of 180 degrees from the detected pressure; and
amplifying the alternating current signal that is generated; and
if the mean peak pressure continues to exceed the maximum endurable pressure, increasing the phase difference of the alternating current signal that is generated.
